(19) United States
(12) Patent Application Publication
(10) Pub. No.: US 2026/0132672 A1
(43) Pub. Date: May 14, 2026

(54) THERMORESPONSIVE ENERGY SAVING SMART WINDOW

(71) Applicant: Rensselaer Polytechnic Institute, Troy, NY (US)

(72) Inventors: Gregory Parisi, Troy, NY (US); Shankar Narayan, Latham, NY (US); Xuanjie Wang, Troy, NY (US)

(73) Assignee: Rensselaer Polytechnic Institute, Troy, NY (US)

(21) Appl. No.: 19/116,511

(22) PCT Filed: Aug. 4, 2023
(86) PCT No.: PCT/US2023/029517

§ 371 Date: Mar. 28, 2025

Related U.S. Application Data
(60) Provisional application No. 63/412,963, filed on Oct. 4, 2022.

(51) Int. Cl. E06B 3/67; G02F 1/01

(52) U.S. Cl. CPC E06B 3/6722; G02F 1/0147

(57) ABSTRACT

A thermoresponsive smart window is provided. The window includes a first windowpane that is positioned at a first side 2024/076415 of the window, a second windowpane that is positioned at a second side of the window opposite the first side, and a gap between the first windowpane and the second windowpane. A thermoresponsive liquid mixture is within the gap. The thermoresponsive liquid mixture is configured to display a phase separation at a lower critical solution temperature such that the window is configured to dynamically and passively switch between a transparent state and a translucent state.

WO

### CROSS REFERENCE TO RELATED APPLICATIONS

This application claims the priority benefit of U.S. Provisional Ser. No. 63/412,963, filed Oct. 4, 2022, which is incorporated by reference as if disclosed herein in its entirety.

### STATEMENT REGARDING FEDERALLY SPONSORED RESEARCH OR DEVELOPMENT

The present invention was made with government support under Grant No. 1944323 awarded by the National Science Foundation and Grant No. 80NSSC21K 0072 awarded by the National Aeronautics and Space Administration. The government has certain rights in the invention.

### FIELD

The present technology relates generally to the field of smart windows, and more particularly, to thermoresponsive smart windows.

### BACKGROUND

Energy use in recent years has become more crucial as the global population increases and energy consumption rapidly increases. One of the largest energy-consuming sectors is the building sector, which is estimated to account for more than a third of the world's energy consumption. Windows are a crucial component of a building and provide light illumination, aesthetics, noise insulation, and thermal insulation, which contributes to high building energy consumption. Smart windows are one solution to reduce energy usage by changing the solar transmission of a window dynamically and reversibly.

Smart windows automatically adjust the amount of light or thermal radiation that can enter, which can be used for privacy control or self-cooling the internal air of a building, reducing the energy usage and fossil fuel consumption from air conditioning. Light transmission modulation can be achieved by thermochromism, electrochromism, or photochromism. Thermochromic smart windows can switch states without the use of additional switches, manual controls, or electricity, which make them auto driven by temperature only. Recent solutions utilize thermal responsive hydrogels. However, hydrogel preparation is a lengthy process, containing many chemicals, and can be expensive. The preparation can also be difficult with multiple steps involving difficult chemical processing.

What is needed, therefore, is an improved smart window that addresses at least the problems described above.

### SUMMARY

According to an embodiment of the present technology, a thermoresponsive smart window is provided. The window includes a first windowpane that is positioned at a first side of the window, a second windowpane that is positioned at a second side of the window opposite the first side, and a gap between the first windowpane and the second windowpane. A thermoresponsive liquid mixture is within the gap. The thermoresponsive liquid mixture is configured to display a phase separation at a lower critical solution temperature such that the window is configured to dynamically and passively switch between a transparent state and a translucent state.

In some embodiments, the thermoresponsive liquid mixture includes a nonionic surfactant and distilled water. In some embodiments, the nonionic surfactant is a secondary alcohol ethoxylate.

In some embodiments, the thermoresponsive liquid mixture further includes an inorganic salt, an ionic surfactant, an alcohol, or combinations thereof.

In some embodiments, the thermoresponsive liquid mixture is formed by dissolving 0.4% of the secondary alcohol ethoxylate in 100 mL of the distilled water and stirring the mixture at 500 revolutions per minute (“RPM”) for 10 minutes. In some embodiments, the thermoresponsive liquid mixture is further formed by adding 0.8 M NaCl and stirring the mixture at 500 RPM for an additional 10 minutes.

In some embodiments, the lower critical solution temperature is in the range of about 34° C. to about 39° C. In some embodiments, the lower critical solution temperature is about 39° C. In some embodiments, the lower critical solution temperature is about 34° C.

In some embodiments, the gap has a width as measured between the first windowpane and the second windowpane. The width of the gap is in the range of about 0.5 cm to about 2.0 cm. In some embodiments, the width of the gap is about 1.25 cm.

According to another embodiment of the present technology, a method of forming a thermoresponsive smart window is provided. The method includes providing a first windowpane; providing a second windowpane; positioning the first windowpane and the second windowpane adjacent each other such that a gap is formed therebetween; forming a thermoresponsive liquid mixture, the thermoresponsive liquid mixture is configured to display a phase separation at a lower critical solution temperature; and filling the gap with the thermoresponsive liquid mixture such that the window is configured to dynamically and passively switch between a transparent state and a translucent state at the lower critical solution temperature.

In some embodiments, the thermoresponsive liquid mixture includes a nonionic surfactant and distilled water. In some embodiments, the nonionic surfactant is a secondary alcohol ethoxylate.

In some embodiments, the thermoresponsive liquid mixture further includes an inorganic salt, an ionic surfactant, an alcohol, or combinations thereof.

In some embodiments, forming the thermoresponsive liquid mixture includes dissolving 0.4% of the secondary alcohol ethoxylate in 100 mL of the distilled water; and stirring the mixture at 500 revolutions per minute (“RPM”) for 10 minutes. In some embodiments, forming the thermoresponsive liquid mixture further includes adding 0.8 M NaCl; and stirring the mixture at 500 RPM for an additional 10 minutes.

In some embodiments, the lower critical solution temperature is in the range of about 34° C. to about 39° C. In some embodiments, the lower critical solution temperature is about 39° C. In some embodiments, the lower critical solution temperature is about 34° C.

In some embodiments, the gap has a width as measured between the first windowpane and the second windowpane. The width of the gap is in the range of about 0.5 cm to about 2.0 cm. In some embodiments, the width of the gap is about 1.25 cm.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a perspective view of a thermoresponsive smart window, showing the switching mechanism of the smart window, according to an embodiment of the present technology.

FIG. 2A is a chart showing the cloud point transition with an increase of temperature for one embodiment of the thermoresponsive liquid mixture of the smart window of FIG. 1. FIG. 2B is a chart showing the cloud point transition with an increase of temperature for another embodiment of the thermoresponsive liquid mixture.

FIG. 3 shows top plan views of the dynamic switching of one embodiment of the thermoresponsive liquid mixture between clear and cloudy states.

FIG. 4A is a chart showing UV-VIS results of a first embodiment of the thermoresponsive liquid mixture in a 0.5 cm gap window. FIG. 4B is a chart showing UV-VIS results of the first embodiment of the thermoresponsive liquid mixture in a 1.25 cm gap window. FIG. 4C is a chart showing UV-VIS results of the first embodiment of the thermoresponsive liquid mixture in a 2.0 cm gap window. FIG. 4D is a chart showing UV-VIS results of a second embodiment of the thermoresponsive liquid mixture in a 0.5 cm gap window. FIG. 4E is a chart showing UV-VIS results of the second embodiment of the thermoresponsive liquid mixture in a 1.25 cm gap window. FIG. 4F is a chart showing UV-VIS results of the second embodiment of the thermoresponsive liquid mixture in a 2.0 cm gap window.

FIG. 5 is a chart showing the percent transmittance difference with different gap widths for a first embodiment of the thermoresponsive liquid mixture and a second embodiment of the thermoresponsive liquid mixture.

FIG. 6 is a chart showing the switchability of transmittance between clear and cloudy states of an embodiment of the thermoresponsive liquid mixture.

FIG. 7A is a chart showing UV-VIS results of different widths window gaps of a control mixture. FIG. 7B is a chart showing UV-VIS results of different thickness window gaps of a first embodiment of the thermoresponsive liquid mixture. FIG. 7C is a chart showing UV-VIS results of different widths window gaps of a second embodiment of the thermoresponsive liquid mixture.

FIG. 8 is a top plan view of an experimental setup used to test one embodiment of the thermoresponsive smart window.

FIG. 9A is a chart plotting temperature against time for the solar absorber of FIG. 8 with the light source going through a control mixture. FIG. 9B is a chart plotting temperature against time for the solar absorber with the light source going through an embodiment of the thermoresponsive liquid mixture.

FIG. 10A is a chart plotting temperature against time for three different gap widths for a control mixture window. FIG. 10B is a chart plotting temperature against time for three different gap widths for an embodiment of the thermoresponsive liquid mixture window.

FIG. 11 is a chart comparing the temperature difference for three different gap widths for a first embodiment of the thermoresponsive liquid mixture and a second embodiment of the thermoresponsive liquid mixture.

FIG. 12A is a chart plotting temperature against time for an outdoor experiment of a model house having a control window and a model house having an embodiment of the thermoresponsive liquid mixture window. FIG. 12B is a chart of the outdoor solar radiation through the duration of the experiment of FIG. 12A.

### DETAILED DESCRIPTION

Accordingly, embodiments of the present technology are directed to a thermoresponsive energy saving smart window. The smart window is configured to dynamically and passively respond to external stimuli which in return controls the amount of light passage through the window. As the smart window switches between transparent (i.e., clear) and translucent (i.e., cloudy), less light passes through the window, allowing the room to self-cool, thereby reducing energy usage and fossil fuel consumption. In some embodiments, the smart window includes a thermoresponsive surfactant, such as Tergitol 15-S-7, that dynamically and passively switches its transmittance when the cloud point of 39° C. is reached. In some embodiments, the temperature of a model house with the liquid responsive window achieves an indoor temperature 7° C. less than a comparison house without the smart window.

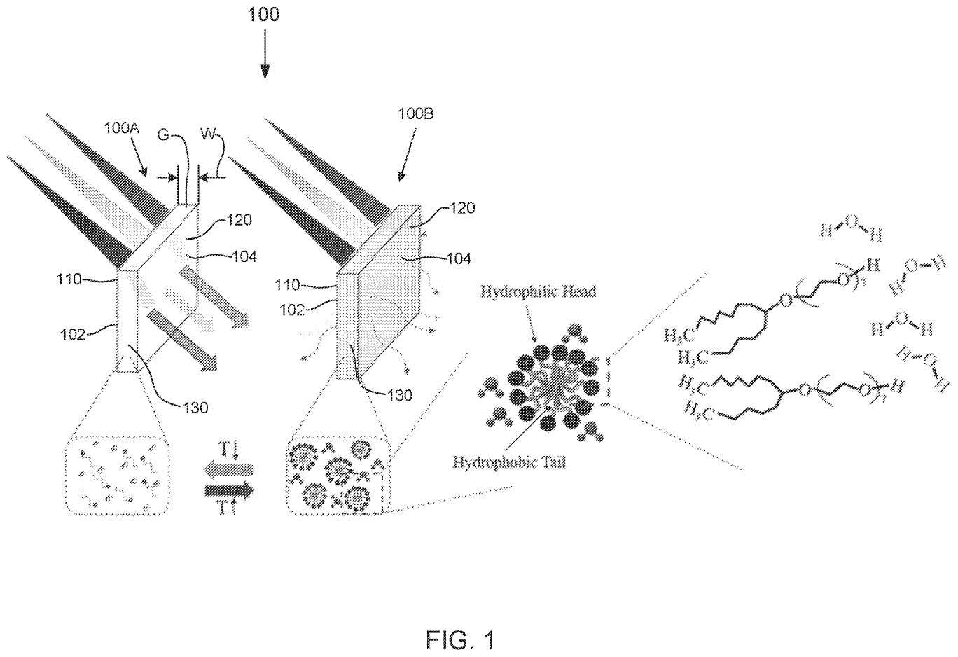

As shown in FIG. 1, a thermoresponsive energy saving smart window is generally designated by the numeral 100. The window 100 includes a first windowpane 110 positioned at a first side 102 of the window 100, and a second windowpane 120 positioned at a second side 104 of the window 100 opposite the first side 102. The windowpanes 110, 120 may be formed of any window material known in the art, such as glass, plexiglass, acrylic, polycarbonate, etc. The first windowpane 110 and the second windowpane 120 are positioned adjacent each other such that a gap G is formed between the first windowpane 110 and the second windowpane 120. The gap G has a width W as measured between the first windowpane 110 and the second windowpane 120.

The gap G is substantially filled, and in some embodiments completely filled, with a thermoresponsive liquid mixture 130. The mixture 130 is configured to display a phase separation (also referred to herein as a cloud point) when the mixture 130 reaches a lower critical solution temperature (also referred to herein as a cloud point temperature) such that the window 100 is configured to dynamically and passively switch between a transparent state 100A and a translucent state 100B based on the temperature of the mixture 130. The lower critical solution temperature is the critical temperature below which the components of the mixture are miscible in all proportions.

In some embodiments, the mixture 130 includes a nonionic surfactant and distilled (“DI”) water. In some embodiments, the nonionic surfactant is a secondary alcohol ethoxylate. In one exemplary embodiment, the secondary alcohol ethoxylate is 0.4% Tergitol 15-S-7 (also referred to herein as “0.4% Tergitol” and “Tergitol”). In some embodiments, the mixture 130 is formed by dissolving 0.4% Tergitol in 100 mL DI water and stirring the mixture at 500 revolutions per minute (“RPM”) for 10 minutes. In some embodiments, the mixture 130 also includes an inorganic salt, an ionic surfactant, an alcohol, or combinations thereof. In another exemplary embodiment, the mixture 130 also includes NaCl and is formed by adding 0.8 M NaCl to the 0.4% Tergitol mixture 130 discussed above and stirring the mixture at 500 RPM for an additional 10 minutes. Although embodiments discussed herein use Tergitol, the present technology is not limited thereto and contemplates embodiments that use any other nonionic surfactant in the thermoresponsive liquid mixture 130, provided that the nonionic surfactant is suitably soluble in water and configured to display a sufficient phase separation at a lower critical solution temperature that is substantially within the ranges discussed herein.

In some embodiments, the lower critical solution temperature is in the range of about 34° C. to about 39° C. In the exemplary embodiment discussed above having the 0.4% Tergitol mixture 130, the lower critical solution temperature is about 39° C. In the exemplary embodiment discussed above having the 0.4% Tergitol with 0.8 M NaCl mixture 130, the lower critical solution temperature is about 34° C.

In some embodiments, the width W of the gap G between the windowpanes 110, 120 is in the range of about 0.5 cm to about 2.0 cm. In some embodiments, the width W of the gap G is about 0.5 cm. In some embodiments, the width W of the gap G is about 1.25 cm. In some embodiments, the width W of the gap G is about 2.0 cm. In some embodiments, the first windowpane 110 and the second windowpane 120 are separate panes such that the window 100 can be positioned within a window frame to form a double-pane smart window. In some embodiments, the first windowpane 110 and the second windowpane 120 are integrally formed and define an interior gap that is filled with the mixture 130 such that the window 100 can be positioned with a window frame to form a single-pane smart window.

In some embodiments, Tergitol solution in water turns cloudy when the solution temperature reaches 39° C. This occurs because the Tergitol molecules can self-assemble into micelles above the critical micellization temperature. This self-assembly results from a balance of electrostatic interactions, hydrophobic associations, hydrogen bonds, Van Der Waals forces and other weak interactions. Hydration within the mixture is decreased at higher temperatures, leading to chain-chain interactions within the Tergitol molecules and leads to phase separation. This phase separation is observed with the presence of a cloudy solution and a translucent mixture. The smart window 100 with the thermal responsive mixture 130 is shown in FIG. 1. Additionally, the cloud point of the solution can be manipulated by the addition of inorganic salts, ionic surfactants, or alcohols.

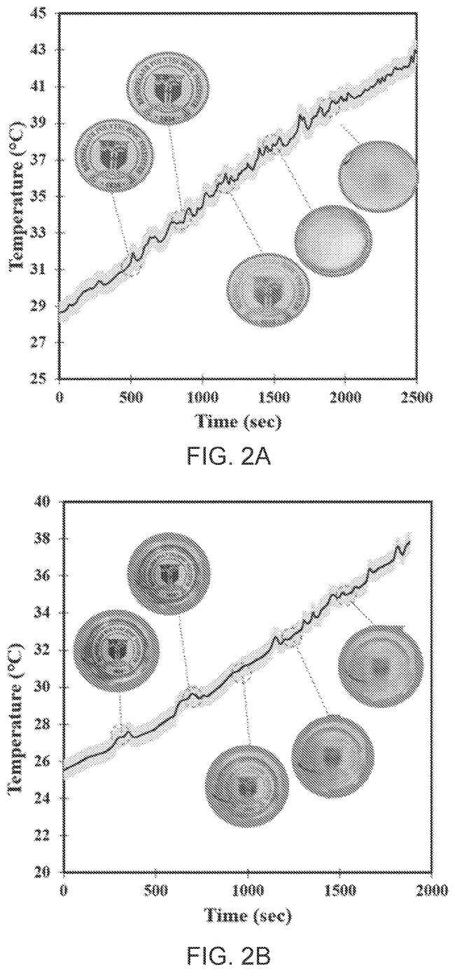

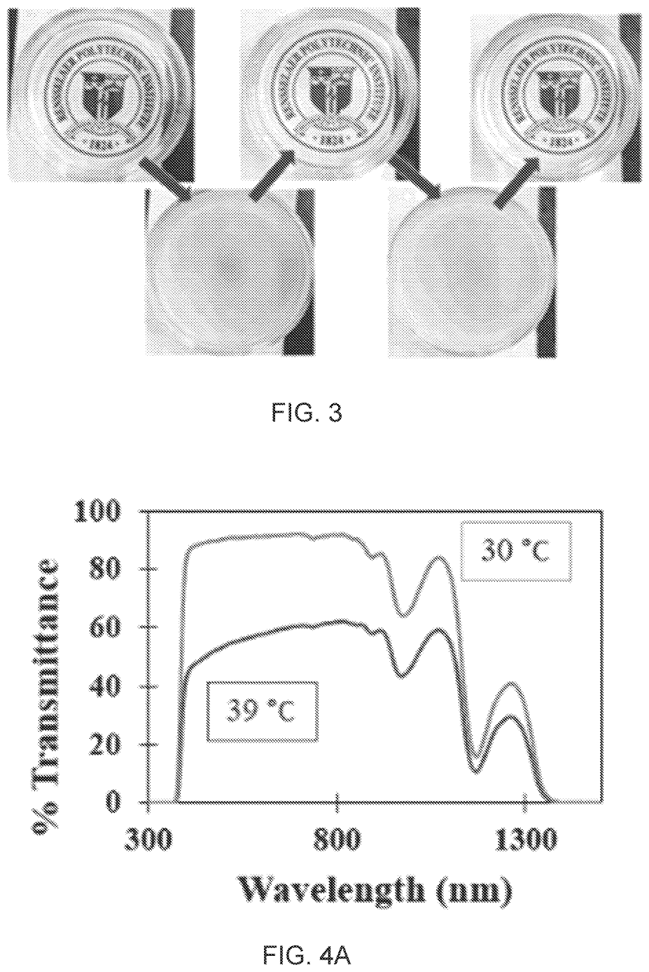

In an exemplary embodiment, 0.4 % Tergitol 15-S-7 was dissolved in 100 ml of DI water (w/w). The mixture was stirred at 500 RPM for 10 minutes. In another exemplary embodiment, the same preparation was carried out for the solution containing a salt to lower the cloud point by introducing 0.8 M NaCl into the above-mentioned mixture and stirring at 500 RPM for an additional 10 minutes. In one embodiment, a J-type thermocouple was placed into the 0.4 % Tergitol mixture and monitored as the solution was heated at about 0.3°C. per minute. The cloud point transition is shown in FIG. 2A, where the complete cloud point temperature is 39° C. In another embodiment, the same procedure was carried out for 0.4 % Tergitol solution with 0.8 M NaCl, as shown in FIG. 2B. The reversible switching between the two states is shown in FIG. 3, where the logo on the glass can only be clearly seen at a temperature below 39° C. during the clear (i.e., transparent) state.

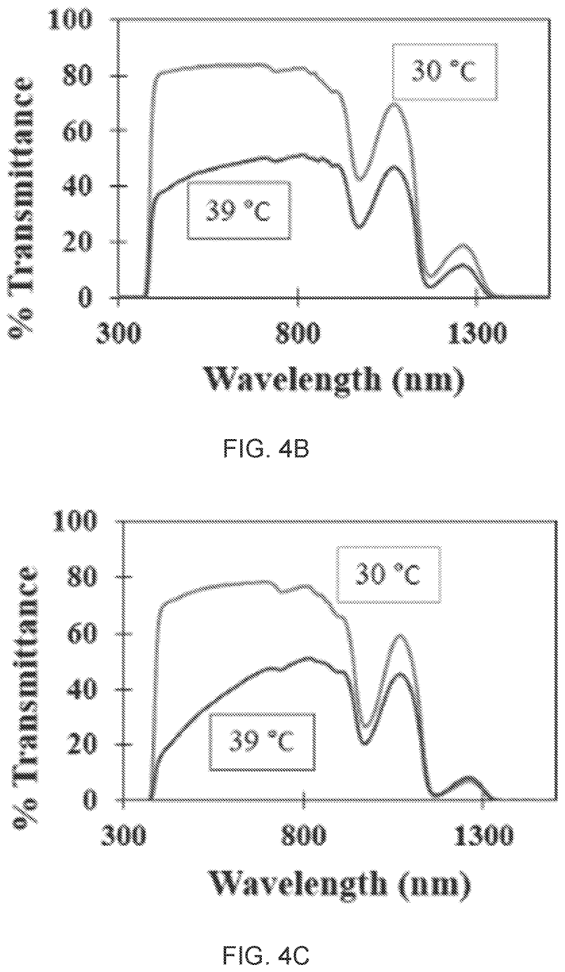

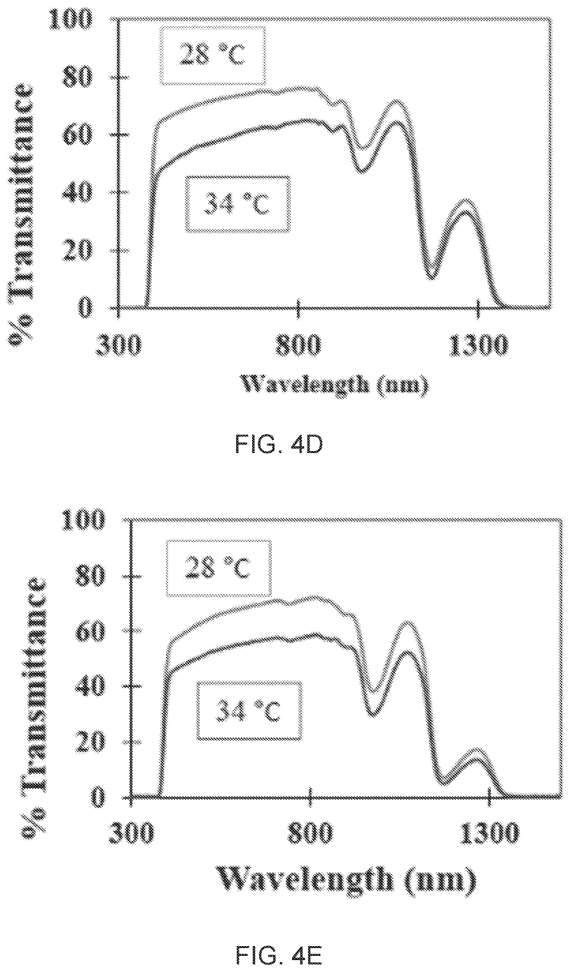

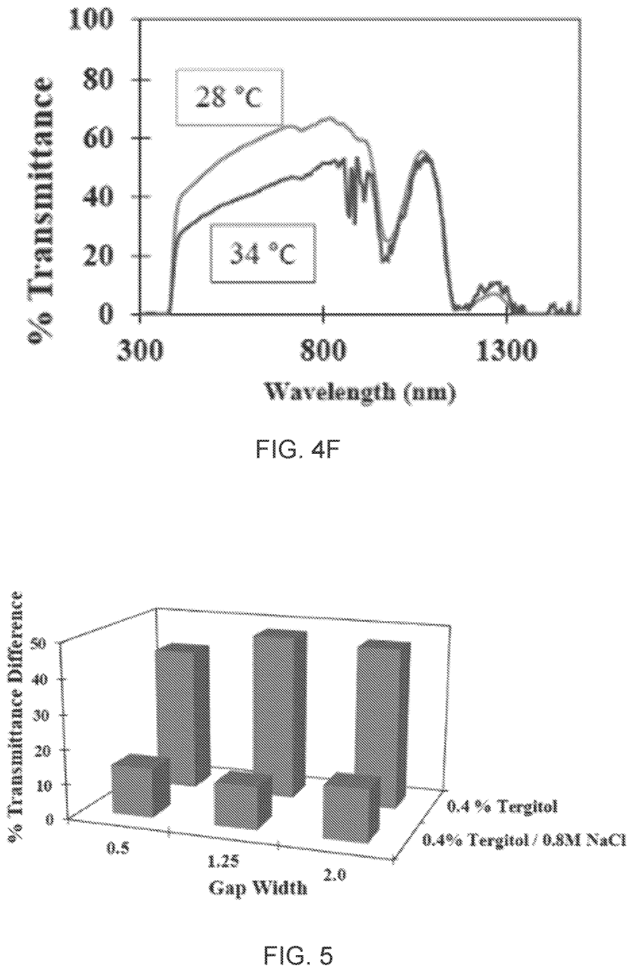

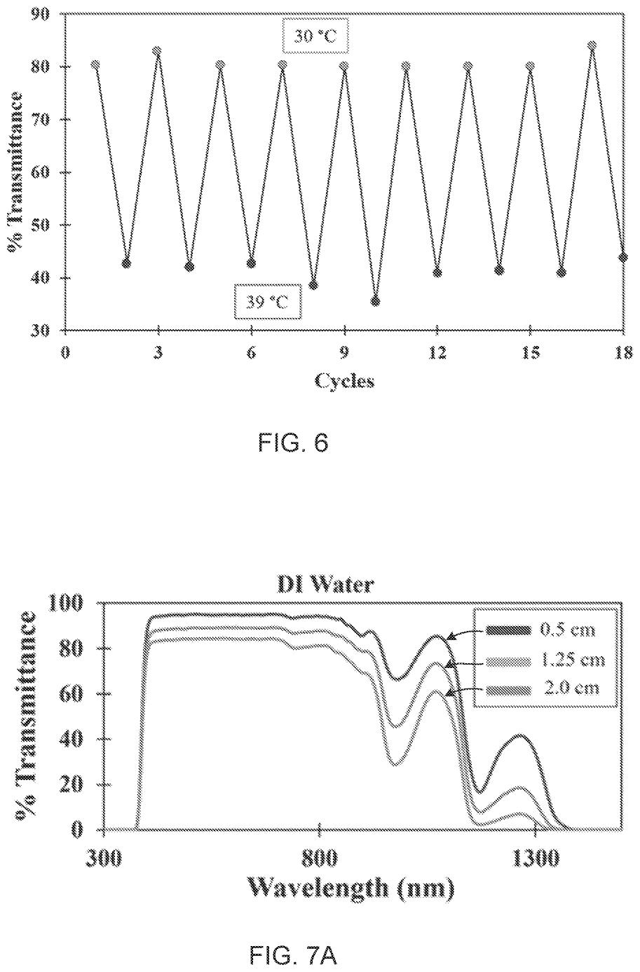

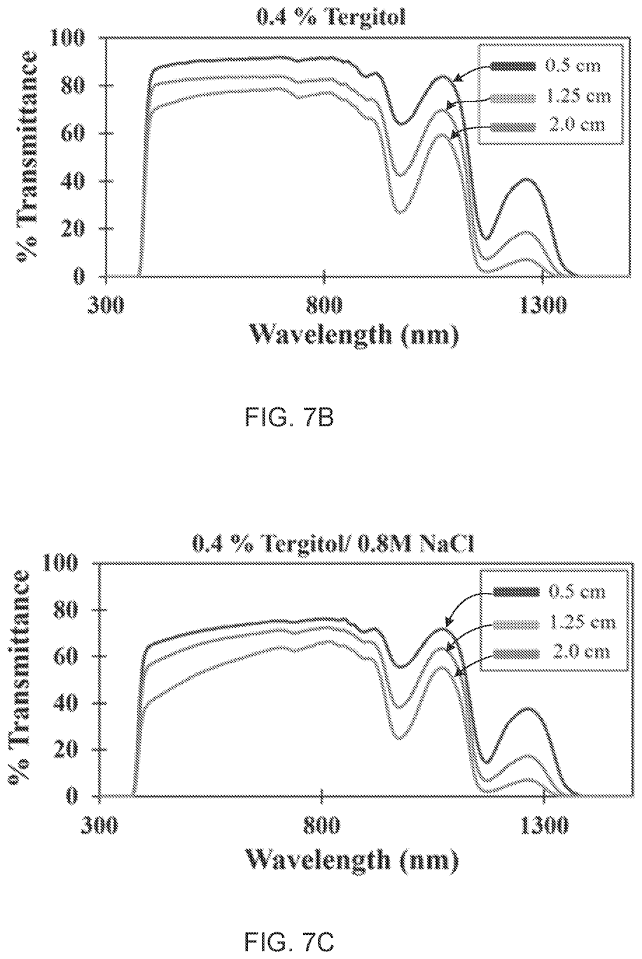

In some embodiments, to determine the difference between the clear state and the cloudy state, ultraviolet and visible spectrometry (“UV-VIS”) was determined for the 0.4% Tergitol solution, and the 0.4% Tergitol with 0.8M NaCl solution. FIGS. 4A-4F show the difference between the cooler clear state and the warmer cloudy state. The 0.4% Tergitol solution has a cloud point temperature around 39° C. and the % transmittance decreases as the cloud point is reached. As the width of the window gap increases, the clear state and the cloudy state % transmittance decreases. With the addition of 0.8 M NaCl, the cloud point is reduced to 34° C., switching transparency states at a lower temperature. As shown, the % transmittance is dependent on the window gap thickness, for both mixtures of 0.4% Tergitol with and without the salt addition. In all the embodiments shown in FIGS. 4A-4F, the transmittance is not as low when salt is added to the mixture, indicating one preferred embodiment would be without any salt addition. Although the cloudy state transmittance decreases with an increase of window gap size, so does the transmittance when the window is clear. Therefore, it was determined that the largest % transmittance difference is with a 1.25 cm gap width and with the 0.4% Tergitol solution, which is shown in FIG. 5. The switching between the clear and cloudy state is completely reversible and is demonstrated by taking UV-VIS readings between the two states over 18 cycles, as shown in FIG. 6. To demonstrate the decrease in transmittance with increase of gap width, UV-VIS was measured for the clear state of the 0.4% Tergitol solution and the 0.4% Tergitol with 0.8M NaCl solution compared with a window filled with DI water, as shown in FIGS. 7A-7C. In all the embodiments shown in FIGS. 7A-7C, the transmittance decreases with an increase of gap thickness.

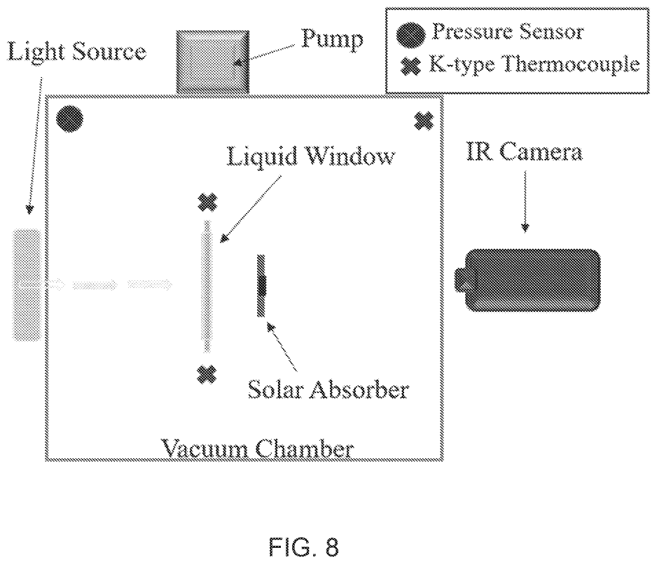

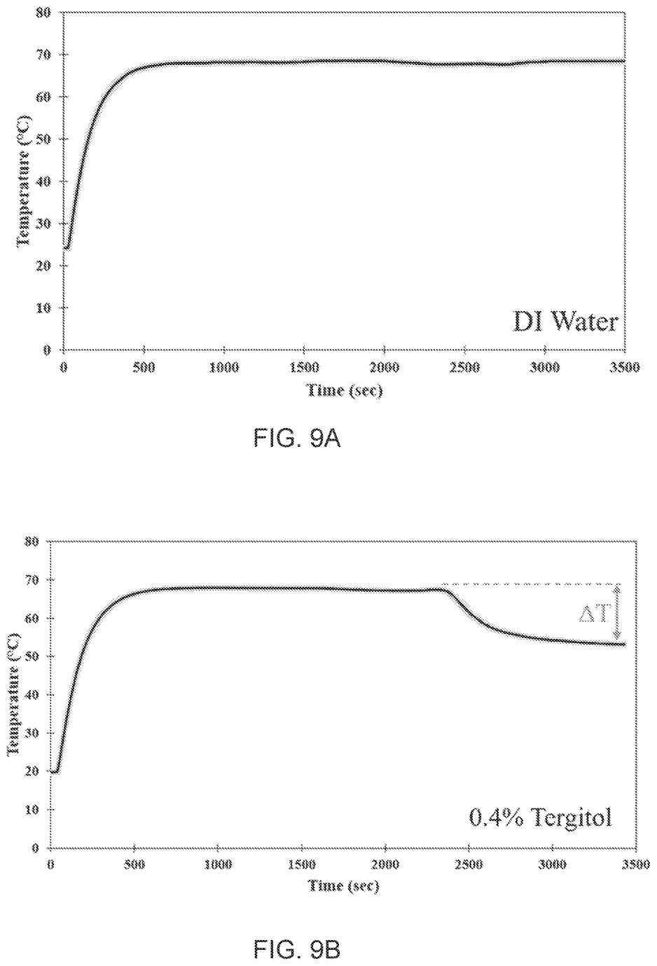

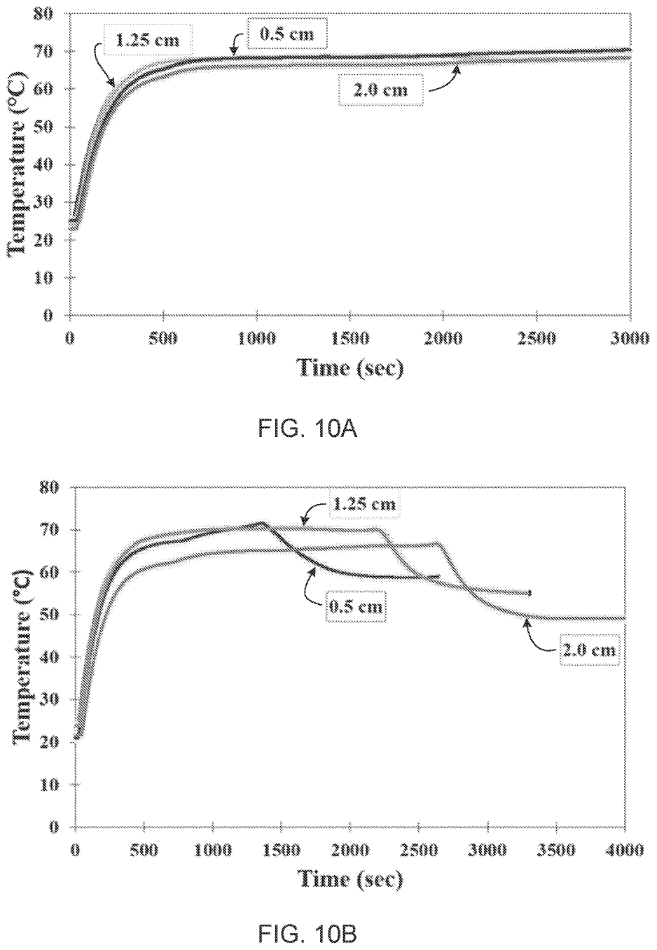

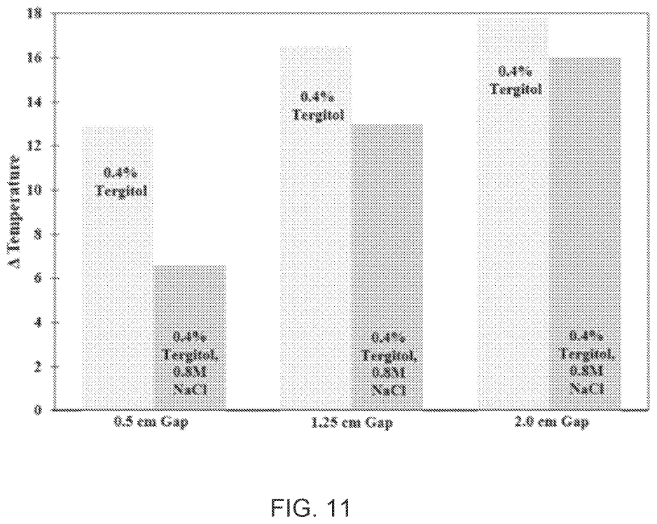

In one embodiment, an experiment was conducted where the liquid-filled window and a selective solar absorber were placed inside a vacuum chamber, to represent an ideal situation, as shown in FIG. 8. The liquid window was placed between the light source and the solar absorber. The temperature of the solar absorber was monitored with the use of an infrared (“IR”) camera. The pressure of the chamber was maintained below 100 Pa for all experiments. The temperature of the solar absorber was monitored over time and reached steady state temperature after about 600 seconds. For an embodiment having a window, with a gap thickness of 1.25 cm, and filled with DI water, steady state temperature held steady since the solution allowed light to continuously pass through the window if the light source is on. In an exact same experimental procedure, light was shining through a window filled with thermoresponsive 0.4% Tergitol solution at 1000 W/m². Steady state temperature was reached, once again, around 600 seconds, but the cloud point temperature of the window was reached at around 2,500 seconds and the solution became cloudy, allowing less light to shine through the window. This in turn absorbed, scattered, and reflected the light, allowing less thermal radiation to encounter the solar absorber. Over time, the solar absorber cooled down with no outside interference. The temperature over time for both the DI water and 0.4% Tergitol solution is shown in FIGS. 9A-9B. As expected, as the window gap thickness changed (for 0.5 cm, 1.25 cm, or 2.0 cm) with a window filled with DI water, there was no temperature change once the steady state temperature was reached. However, when 0.4% Tergitol solution was placed in the window, the cloud point was reached and the temperature of the solar absorber decreases. Depending on the window gap thickness, the temperature was reached quicker or slower since a smaller gap thickness will contain less volume and therefore less thermal mass. This difference is shown in FIGS. 10A-10B, where the decrease in gap thickness will have a quicker cloud point transition, allowing the solar absorber to cool quicker. However, since the % transmittance is also decreased with increased gap thickness, there is also an overall temperature change that increases with the increase of the gap thickness. In some embodiments, the lowest temperature is reached with the largest gap thickness of 2.0 cm, although it is the slowest to respond. This change in temperature for the two different Tergitol solutions is shown in FIG. 11, with an overall increasing temperature difference trend with an increase of gap thickness.

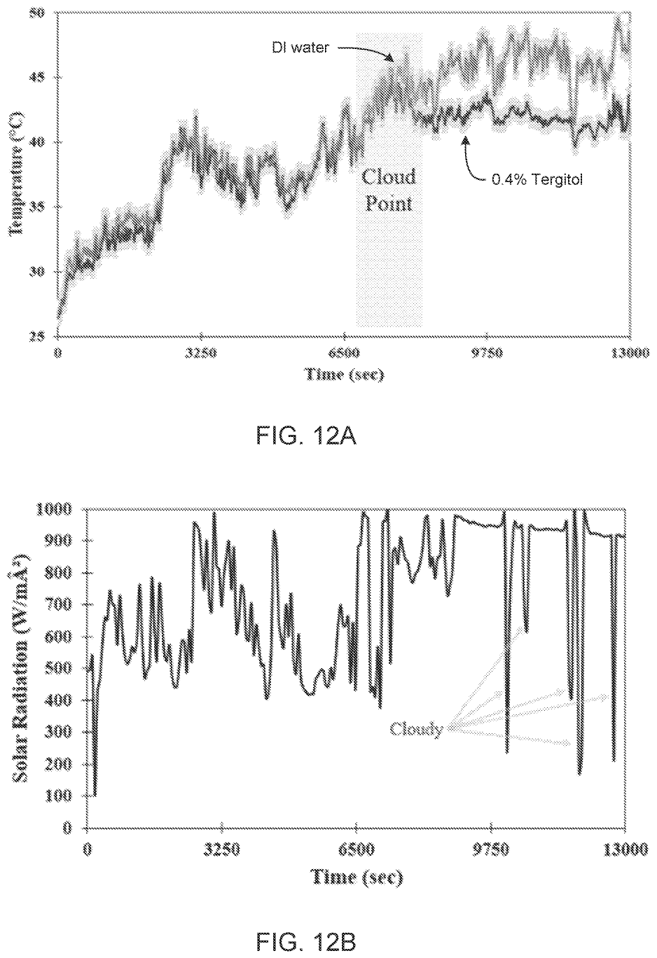

In another embodiment, the temperature of the inside of a model house was monitored outside on the roof top of a building. The model house was built out of thermal insulation board and covered completely by aluminum foil to reflect much of the light that did not penetrate the liquid window. The temperature of the inside of the house was monitored using J-type thermocouples, one placed into a house with DI water as a window (control) and another placed in the other house with 0.4% Tergitol filled window. As the solar radiation increased, and the temperature became warmer throughout the day, both houses heated up. However, once the internal temperature of the liquid window surpassed the cloud point of the 0.4% Tergitol window, the solution became cloudy, creating a self-cooling effect within the inside of the house. As expected, once the cloud point was reached, the solution became turbid and less solar radiation entered the model house compared to the control house with the window filled with DI water. At roughly 7,000 seconds, about 2:15 pm in the afternoon, the cloud point was reached, and the temperature of the model house remained constant, compared to the model house with a window that does not switch continued to heat up throughout the afternoon. The temperature difference between both houses is shown in FIG. 12A, and the solar radiation that day captured by a pyranometer is shown in FIG. 12B.

Accordingly, embodiments of the present technology are directed to a smart window that can passively and dynamically switch between a clear and cloudy state, which can be used in homes and buildings to save on the use of air conditioning, which will use less fossil fuels. This type of window would be useful in hot regions where temperatures are warm during the day and can self-cool the inside of the building without the use of electricity. This type of technology not only combats the ongoing global warming issue but can also save money on indoor cooling. As shown herein, the indoor temperature of a model house with the smart window shows an indoor temperature that is 7° C. less than the control model house without the smart window. The use of this type of window can be used to save energy usage as well as energy costs that arise from the use of air conditioning. Embodiments of the liquid responsive window disclosed herein are also more efficiently and more cost-effectively manufactured than similar windows which contain photochromic properties or thermally responsive hydrogels.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1. A thermoresponsive smart window comprising:
a first windowpane positioned at a first side of the window;
a second windowpane positioned at a second side of the window opposite the first side;
a gap between the first windowpane and the second windowpane; and
a thermoresponsive liquid mixture within the gap, the thermoresponsive liquid mixture is configured to display a phase separation at a lower critical solution temperature such that the window is configured to dynamically and passively switch between a transparent state and a translucent state.

2. The thermoresponsive smart window of claim 1, wherein the thermoresponsive liquid mixture comprises a nonionic surfactant and distilled water.

3. The thermoresponsive smart window of claim 2, wherein the nonionic surfactant comprises a secondary alcohol ethoxylate.

4. The thermoresponsive smart window of claim 2, wherein the thermoresponsive liquid mixture further comprises an inorganic salt, an ionic surfactant, an alcohol, or combinations thereof.

5. The thermoresponsive smart window of claim 3, wherein the thermoresponsive liquid mixture is formed by dissolving 0.4% of the secondary alcohol ethoxylate in 100 mL of the distilled water and stirring the mixture at 500 revolutions per minute (“RPM”) for 10 minutes.

6. The thermoresponsive smart window of claim 5, wherein the thermoresponsive liquid mixture is further formed by adding 0.8 M NaCl and stirring the mixture at 500 RPM for 10 minutes.

7. The thermoresponsive smart window of claim 1, wherein the lower critical solution temperature is in the range of about 34° C. to about 39° C.

8. The thermoresponsive smart window of claim 5, wherein the lower critical solution temperature is about 39° C.

9. The thermoresponsive smart window of claim 6, wherein the lower critical solution temperature is about 34° C.

10. The thermoresponsive smart window of claim 1, wherein the gap has a width as measured between the first windowpane and the second windowpane, the width is in the range of about 0.5 cm to about 2.0 cm.

11. The thermoresponsive smart window of claim 10, wherein the width of the gap is about 1.25 cm.

12. A method of forming a thermoresponsive smart window, the method comprising:
providing a first windowpane;
providing a second windowpane;
positioning the first windowpane and the second windowpane adjacent each other such that a gap is formed therebetween;
forming a thermoresponsive liquid mixture, the thermoresponsive liquid mixture is configured to display a phase separation at a lower critical solution temperature; and
filling the gap with the thermoresponsive liquid mixture such that the window is configured to dynamically and passively switch between a transparent state and a translucent state at the lower critical solution temperature.

13. The method of claim 12, wherein the thermoresponsive liquid mixture comprises a nonionic surfactant and distilled water.

14. The method of claim 13, wherein the nonionic surfactant comprises a secondary alcohol ethoxylate.

15. The method of claim 12, wherein the thermoresponsive liquid mixture further comprises an inorganic salt, an ionic surfactant, an alcohol, or combinations thereof.

16. The method of claim 14, wherein forming the thermoresponsive liquid mixture comprises:
dissolving 0.4% of the secondary alcohol ethoxylate in 100 mL of the distilled water; and
stirring the mixture at 500 revolutions per minute (“RPM”) for 10 minutes.

17. The method of claim 16, wherein forming the thermoresponsive liquid mixture further comprises:
adding 0.8 M NaCl; and
stirring the mixture at 500 RPM for 10 minutes.

18. The method of claim 12, wherein the lower critical solution temperature is in the range of about 34° C. to about 39° C.

19. The method of claim 16, wherein the lower critical solution temperature is about 39 °C.

20. The method of claim 17, wherein the lower critical solution temperature is about 34° C.

21. The method of claim 12, wherein the gap has a width as measured between the first windowpane and the second windowpane, the width is in the range of about 0.5 cm to about 2.0 cm.

22. The method of claim 21, wherein the width of the gap is about 1.25 cm.
